(19) United States
(12) Patent Application Publication
(10) Pub. No.: US 2004/0203572 A1
(43) Pub. Date: Oct. 14, 2004

(54) Emergency call-back for mobile terminals in a limited service mode

(76) Inventors: Naveen Aerrabotu, Gurnee, IL (US); Charles Binzel, Bristol, WI (US); Varalakshmi Likki, Gurnee, IL (US)

Correspondence Address: MOTOROLA INC, 600 NORTH US HIGHWAY 45, ROOM AS437, LIBERTYVILLE, IL, 60048-5343, US

(21) Appl. No.: 10/334,812

(22) Filed: Dec. 31, 2002

(51) Int. Cl. H04M 11/00; H04M 1/00; H04B 1/38

(52) U.S. Cl. 455/404.1; 455/550.1

(57) ABSTRACT

An apparatus (100) and method (200) for enabling a wireless portable communication device in a limited service mode to receive an incoming call is provided. As the wireless portable communication device in the limited service mode initially makes a call to an emergency service center such as police (214), the call identifies the wireless portable communication device by a user module identity (308) or by an equipment identity (314), enabling the emergency service center to initiate a return call to the wireless portable communication device (216).

### FIELD OF THE INVENTION

The present invention generally relates to an apparatus and a method for receiving an emergency call, and more specifically to an apparatus and a method for receiving an emergency call in a limited service mode.

### BACKGROUND OF THE INVENTION

A wireless radiotelephone, such as a cellular telephone, typically operates in a wireless network by first registering its subscriber identity such as an international mobile subscriber identity (“IMSI”) and a mobile identity number (“MIN”) telephone number, to the network. Once registered, the cellular telephone is allowed to initiate and to receive a call in the network. In a normal mode of operation, the cellular telephone receives an incoming call by monitoring a page for the IMSI address, and accepting the incoming call if the IMSI of the page matches the IMSI of the cellular telephone. If the cellular telephone is not registered, the network may refuse a call initiated by the cellular telephone, and the cellular telephone will not be allowed to receive a call targeted to the cellular telephone. The cellular telephone may become unregistered in several ways. For example, the cellular telephone may no longer have a valid subscription with any wireless network; the cellular telephone may be in a locked mode where a user has failed to properly enter a passcode such as a personal identification number (“PIN”); the cellular telephone may be missing a required user module such as a subscriber identification module (“SIM”) card for a Global System for Mobile Communications (“GSM”) type cellular telephone or a removable user identity module (“R-UIM”) for a code division multiple access (“CDMA”) type cellular telephone; or the current visited network may not have roaming agreement with the subscriber's home network. An unregistered cellular telephone may still operate in a limited service mode in which it is allowed to initiate an emergency call to an emergency service center. A call to the emergency service center may be identified by a prestored telephone number dedicated for emergency, for example, 911 in the United States and 112 in Europe. However, in the limited service mode of operation, the cellular telephone is disallowed to receive any incoming call including a call back from the emergency service center.

### BRIEF DESCRIPTION OF THE DRAWINGS

FIG. 1 is an exemplary block diagram of the present invention.

FIG. 2 is an exemplary flow chart of the first embodiment of the present invention in a wireless portable communication device.

FIG. 3 is an exemplary flow chart describing one of the blocks of FIG. 2.

FIG. 4 is an exemplary block diagram of an environment where the present invention may be practiced.

FIG. 5 is an exemplary flow chart of the second embodiment of the present invention in a wireless portable communication network.

FIG. 6 is an exemplary flow chart describing a call back from the emergency service center to the wireless portable communication device.

### DETAILED DESCRIPTION OF THE PREFERRED EMBODIMENT(S)

The present invention provides an apparatus and method for providing a wireless portable communication device for a predefined period of time to receive an incoming call in response to initiating a call to an emergency service center such as police and fire station while the wireless portable communication device is operating in a limited service mode. When the wireless portable communication device such as a cellular telephone is operating in the limited service mode, the wireless portable communication device is not allowed to make or receive a normal call but is allowed to initiate an emergency call to an emergency service center. The wireless portable communication device may enter the limited service mode by not having a required user module such as a subscriber identification module (“SIM”) card for a Global System for Mobile Communications (“GSM”) type cellular telephone or a removable user identity module (“R-UIM”) for a code division multiple access (“CDMA”) type cellular telephone; receiving an improper password to unlock the user module; by simply not having a valid service subscription; or is barred by the network.

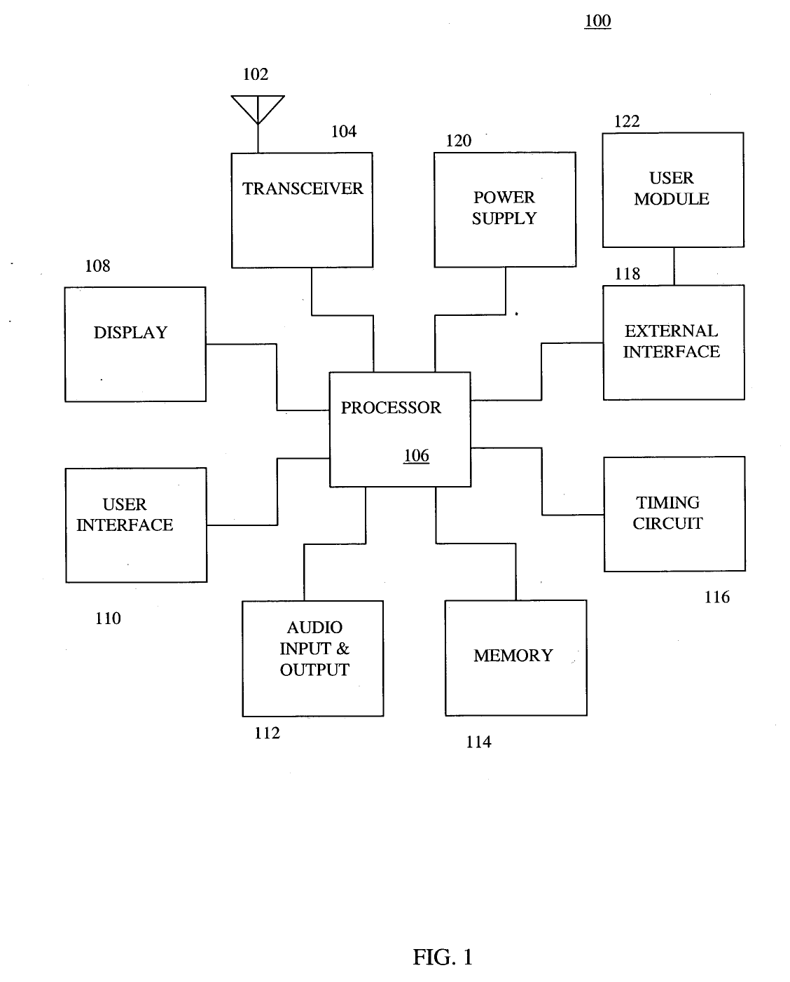

Referring to FIG. 1, there is shown an exemplary wireless portable communication device 100 having emergency call back reception functionality in accordance with the present invention. The device may be, but is not limited to, a radiotelephone (such as a cellular phone or two-way radio), a paging device, a personal digital assistant (“PDA”), a handheld computer, an audio/video device (such as a television or an MP3 player), a network browsing device, a tablet for pen, a touchpad for finger and pen, a touch keypad for finger, a virtual pen, and any type of computing and communicating device. FIG. 1 is a representation of internal components of the exemplary wireless communication device 100. The preferred embodiment includes an antenna 102; a transceiver 104; a processor 106; a display 108; a user interface 110; an audio input & output 112; a memory circuit 114; and a timing circuit 116. Upon reception of wireless signals, the internal components 100 detect the signals through the antenna 102 to producing detected voice and/or data signals. The transceiver 104, coupled to the antenna 102, converts the detected signals into electrical baseband signals and demodulates the electrical baseband signals to recover incoming information, such as voice and/or data, transmitted by the wireless signals. After receiving the incoming information from the transceiver 104, the processor 106 formats the incoming information for output to the display 108 and/or audio input & output 112. Likewise, for transmission of wireless signals, the processor 106 formats outgoing information and conveys it to the transceiver 104 for modulation of a carrier and conversion into modulated signals. The transceiver 104 conveys the modulated signals to the antenna 102 for transmission to a remote transceiver (not shown).

The input and output devices may include a variety of visual, audio and/or motion devices. The output devices may include, but are not limited to, the display 108 (such as liquid crystal displays and light emitting diode indicators) and the audio outputs (such as speakers, alarms and buzzers) of the audio input & output 112. The input devices may include, but are not limited to, the user input 110 (such as keyboards, keypads, selection buttons, touch pads, touch screens, capacitive sensors, motions sensors, and switches) and audio inputs (such as microphones) of the audio input & output 112.

The internal components of the wireless communication device 100 further include the memory circuit 114 for storing and retrieving data and the timing circuit 116. The processor 106 may perform various operations to store, manipulate and retrieve information in the memory circuit 114.

Timing information regarding the predefined period of time for which the wireless portable communication device is able to receive the incoming call is stored in the memory along with duration information specifying how long the predefined period of time has been in effect. The timing circuit 116 may include clock circuitry that provides the current time and/or a timer that provides elapsed time from a particular starting time such as the beginning of the duration of the predefined period of time. It is to be understood that, for the invention described herein, the word “time” is used broadly to include calendar dates as well as times of day. Unless the processor determines that the elapsed time has exceeded the predefined period of time, the processor allows the incoming call to be received while operating in the limited service mode.

The internal components of the wireless communication device 100 may further include a component interface 118 and a power supply 120. Accessories and additional components such as a user module 122 may be coupled to the component interface 118 to provide additional functionality and capabilities to the device 100. The power supply 120, such as a battery, is controlled by the processor 106 and provides power to the internal components so that they may function correctly.

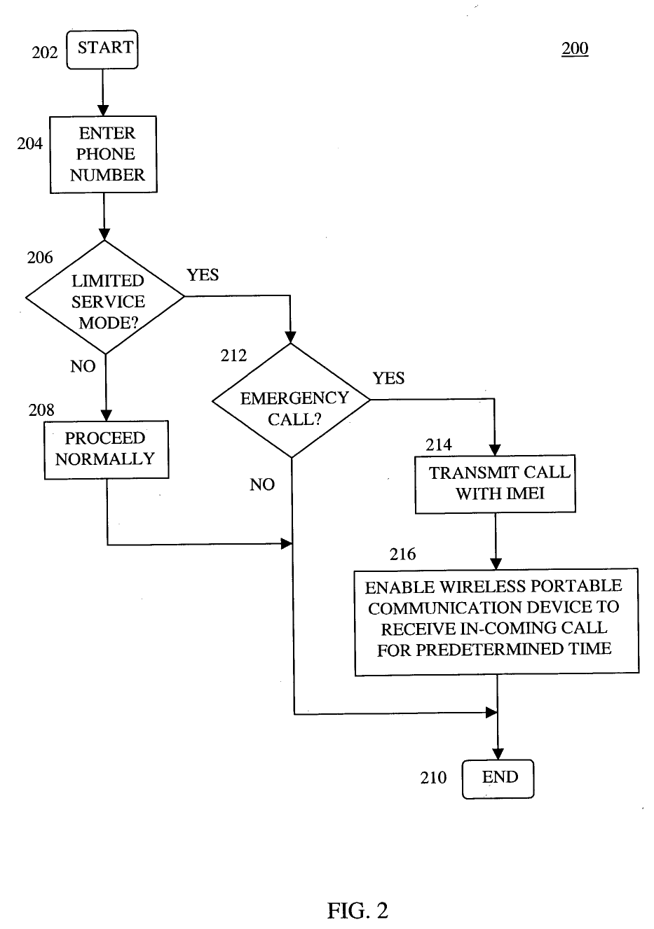

Referring to FIG. 2, there is provided an exemplary flow chart 200 of the first embodiment of the present invention in the wireless portable communication device 100. The process begins in block 202, and when a user of the wireless portable communication attempts to make a call by entering a telephone number to be dialed in block 204, the wireless portable communication device determines whether it is operating in a limited service mode in block 206. If it determines that it is not operating in the limited service mode, then it dials the entered telephone number and proceeds normally in block 208, and the process terminates in block 210. However, if wireless portable communication device determines that it is operating in the limited service mode in block 206, it then determines whether the call is directed to an emergency service center in block 212. The call may be determined to be directed to the emergency service center by comparing the entered telephone number to a prestored telephone number for the emergency service center. Upon determining that the call is directed to the emergency service center in block 212, the wireless portable communication device transmits the call along with its equipment identity information such as its international mobile equipment identity (“IMEI”) in block 214. The wireless portable communication device then is enabled to receive incoming calls for a predefined period of time in block 216, and the process terminates in block 210.

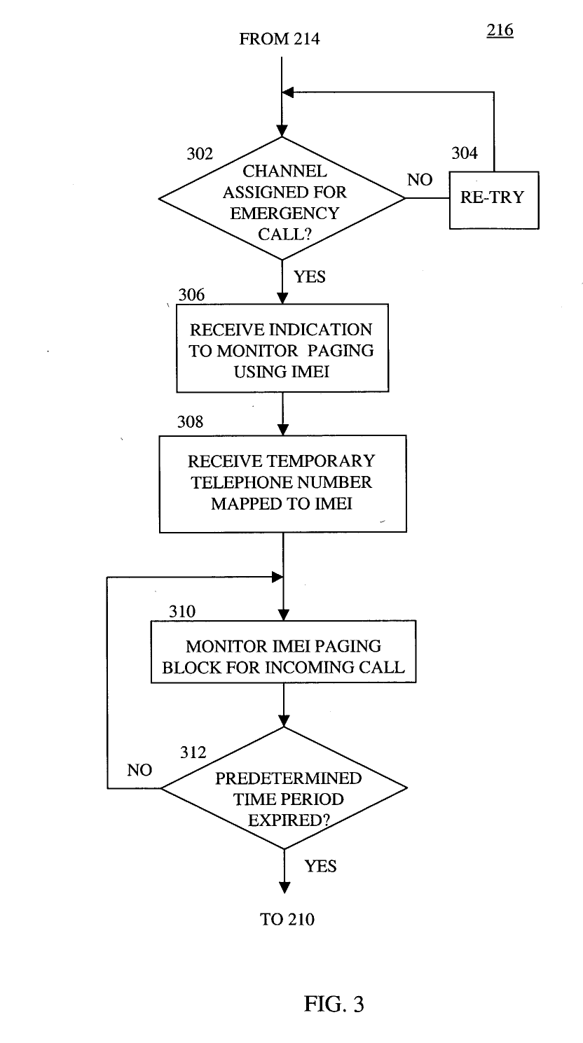

Referring to FIG. 3, there is provided an exemplary flow chart further describing block 216 of FIG. 2. After the wireless portable communication device transmits the call along with its IMEI in block 214, the wireless portable communication device monitors for a channel assignment for the call in block 302, and may re-try the call for a predetermined number of times in block 304 if no channel is assigned to the call, i.e. the call is unsuccessful. Once the call is assigned a channel, the wireless portable communication device receives an indication to begin monitoring paging for incoming calls in block 306. An appropriate paging block where the wireless portable communication device monitors paging for incoming calls is calculated based upon its IMEI. The wireless portable communication device also receives a temporary telephone number mapped to the IMEI in block 308 such that the IMEI and the wireless portable communication device can be identified by the temporary telephone number and vice versa, and monitors paging in the appropriate paging block for incoming calls in block 310. The temporary telephone number may be made available to the user of the portable communication device. However, the temporary telephone number mapped to the IMEI of the wireless portable communication device is maintained only for a predetermined period of time such as 45 minutes or for a time period otherwise specified, and an elapsed time of the predetermined period of time is monitored in block 312. During the predetermined period of time, the wireless portable communication device continues to monitor paging for incoming calls in block 310. Upon expiration of the predetermined period of time, the wireless portable communication device discontinues monitoring paging for incoming call, and the process terminates in block 210.

Monitoring of the elapsed time may be accomplished by marking the start of the predetermined period of time and tracking the elapsed time by using an internal clock of the wireless portable communication device or receiving time information from an external time source such as a network time source. The predetermined period of time may be defined to run from the time the successful channel assignment is made or from the time the first emergency call has terminated. The predetermined period of time may be renewed upon initiating a new emergency call to the emergency service provider, or upon receiving a call back from the emergency service provider.

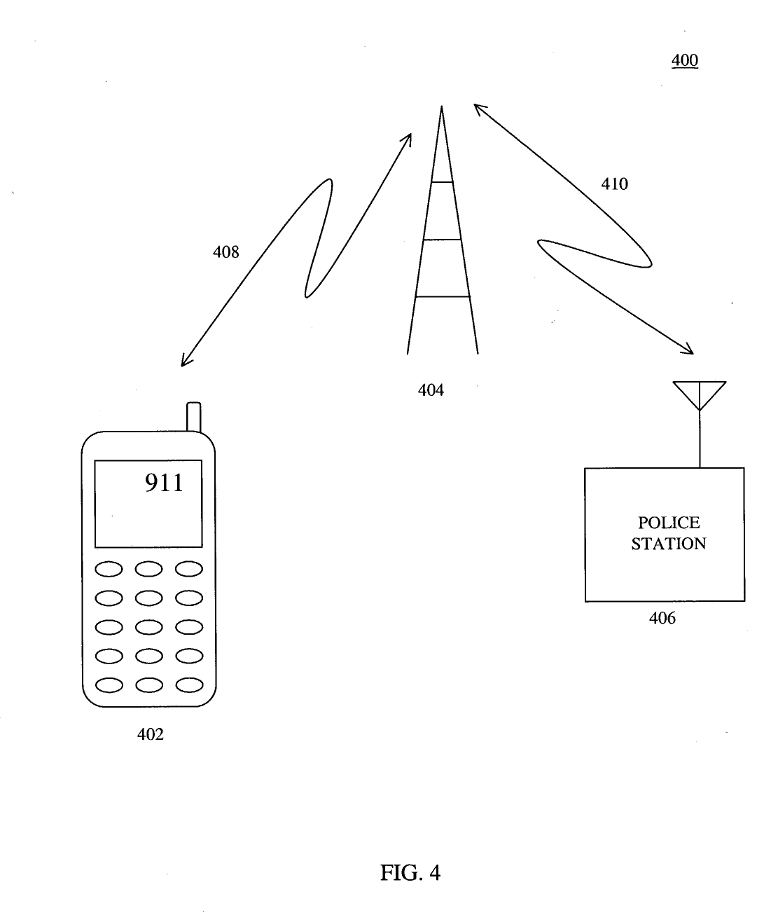

Referring to FIG. 4, there is provided an exemplary block diagram of an environment where the present invention may be practiced. In the exemplary environment, there exits a wireless communication network 400 comprising a wireless portable communication device 402, a base station 404, and an emergency service center 406, all of which may be connected wirelessly as shown with radio frequency signal 408 and 410.

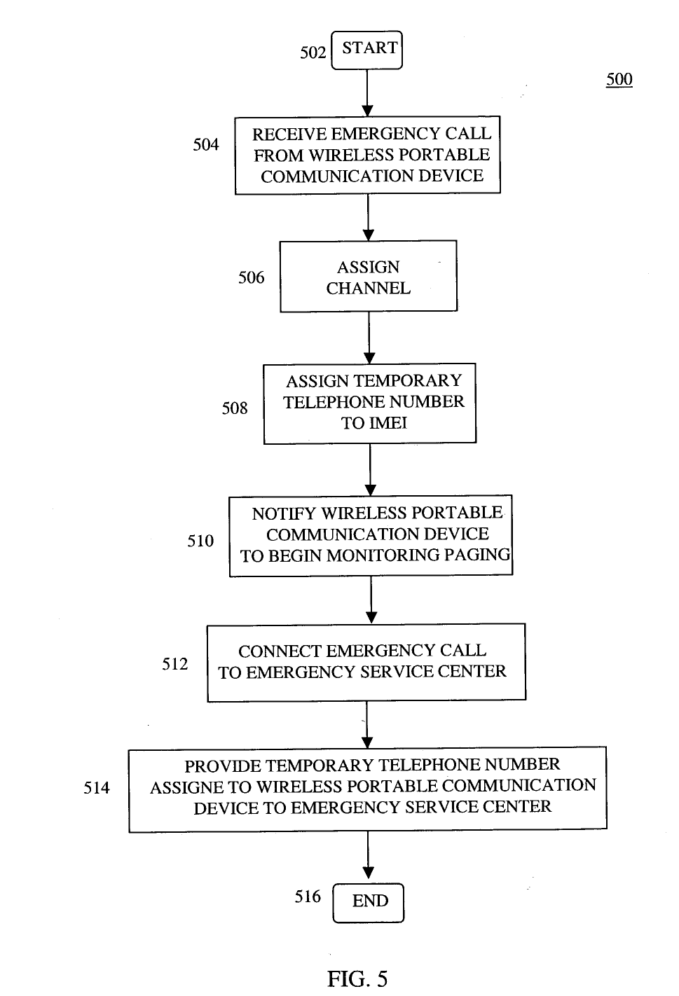

Referring to FIG. 5, there is provided an exemplary flow chart 500 of the second embodiment of the present invention in the wireless communication network. The process begins in block 502, and the network receives an emergency call from the wireless portable communication device operating in a limited service mode in block 504. The network also receives equipment identity information such as the IMEI of the wireless portable communication device along with the emergency call, and the network assigns a channel for the emergency call in block 506. After the channel assignment, the network assigns a temporary telephone number to the IMEI in block 508. The temporary telephone number is mapped such that the IMEI and the wireless portable communication device can be identified by the temporary telephone number and vice versa. However, the network maintains the registered temporary telephone number associated with the IMEI only for a predetermined period of time such as 45 minutes, or for a time period otherwise specified. An elapsed time of the predetermined period of time is monitored, and upon expiration of the predetermined period of time, the network may no longer page the wireless portable communication device based upon the temporary telephone number received. The predetermined period of time may be defined to run from the time the network assigns a channel to the emergency call from the wireless portable communication device or from the time the emergency call has terminated. The predetermined period of time may be renewed upon receiving a new emergency call from the wireless portable communication device, or upon receiving a call back to the wireless portable communication device from the emergency service provider.

The network then notifies the portable communication device to begin monitoring paging in an appropriate paging block in block 510. The appropriate paging block is located by performing a calculation based upon the IMEI of the wireless portable communication device. The network then completes the emergency call by establishing communication with the emergency service center in block 512, provides the emergency service center with the temporary telephone number assigned to the IMEI of the wireless portable communication device in block 514, and the process terminates in block 516.

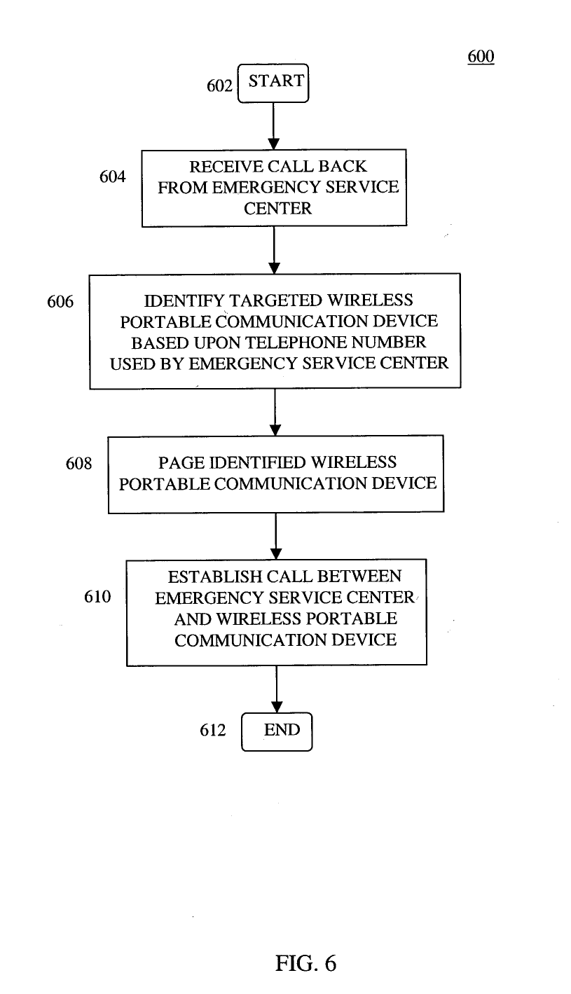

Referring to FIG. 6, there is provided an exemplary flowchart describing a call back process from the emergency service center to the wireless portable communication device. As the process begins in block 602, the network receives a call having the temporary telephone number assigned to the IMEI of the wireless portable communication device from the emergency service center in block 604. By using the temporary telephone number, the network identifies the targeted wireless portable communication device in block 606, and pages the identified wireless portable communication device in block 608. The network locates an appropriate paging block for the wireless portable communication device is by performing a calculation based upon the IMEI of the wireless portable communication device. The network then establishes communication between the emergency service center and the wireless portable communication device in block 610, and the process terminates in block 612.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless portable communication device comprising:
an input interface configured to receive a telephone number;
a processor coupled to the input interface, the processor configured to prevent initiation of a call while the wireless portable communication device is in a limited service mode if the telephone number differs from a predefined telephone number, the processor configured to allow initiation of the call while the wireless portable communication device is in the limited service mode if the telephone number matches the predefined telephone number;
a transmitter coupled to the processor, the transmitter configured to transmit the call if the telephone number matches the predefined telephone number; and
a receiver coupled to the processor, the receiver configured to receive a page after the transmission of the call;
wherein the processor is configured to monitor for a predefined period of time an appropriate paging block based upon an equipment identity of the wireless portable communication device.

2. The wireless portable communication device of claim 1, wherein the processor is configured to monitor a channel assignment for the call.

3. The wireless portable communication device of claim 2, wherein the processor responds to a page having the equipment identity of the wireless portable communication device to receive an incoming call.

4. The wireless portable communication device of claim 3, further comprising:
a timing circuit coupled to the processor configured to generate a start time of the predefined period of time and to provide timing information to the processor; and
a memory circuit configured to store the start time;
wherein the processor determines whether the predefined period of time has past based upon comparison between the start time in the memory circuit and the timing information received from the timing circuit.

5. The wireless portable communication device of claim 4, wherein the processor is configured to place the wireless portable communication device in the limited service mode upon determining the predefined period of time has past.

6. The communication device of claim 5, wherein the timing circuit is configured to provide timing information based upon an external time reference.

6. A method in a wireless portable communication device operating in a limited service mode for enabling to receive an incoming call, the method comprising:
transmitting an emergency call along with equipment identity information of the wireless portable communication device;
receiving an indication to begin monitoring paging for an incoming call;
monitoring an appropriate paging block; and
responding for a predetermined period of time to a page having proper equipment identity information located in the appropriate paging block.

7. The method of claim 6, receiving an indication to begin monitoring paging for an incoming call after a channel is assigned for the emergency call.

8. The method of claim 7, receiving a temporary telephone number mapped to the equipment identity information of the wireless portable communication device after the channel is assigned for the emergency call.

9. The method of claim 8, monitoring an appropriate paging block by monitoring an equipment identity paging block calculated based upon the equipment identity information of the wireless portable communication device.

10. The method of claim 9, responding for a predetermined period of time to a page having proper equipment identity information located in the appropriate paging block by:
storing a start time stamp indicating a start of the predetermined period of time in memory;
tracking an elapsed period of time from the start time stamp; and
responding to the page having proper equipment identity information located in the appropriate paging block during the predetermined period of time.

11. The method of claim 10, tracking an elapsed period of time from the start time stamp by monitoring an internal clock.

12. The method of claim 10, tracking an elapsed period of time from the start time stamp by monitoring an external time reference.

13. The method of claim 10, using the channel assignment as the start of the predetermined period of time.

14. The method of claim 10, using the termination of the emergency call as the start of the predetermined period of time.

15. The method of claim 10, resetting the start time stamp each time an emergency call is made from the wireless portable communication device.

16. The method of claim 10, resetting the start time stamp each time an emergency call is received.

17. A method in a wireless communication network for enabling a wireless portable communication device in a limited service mode to respond to an incoming call, the method comprising:
receiving a first emergency call from the wireless portable communication device;
assigning a channel for the first emergency call;
notifying the wireless portable communication device to begin monitoring paging in an appropriate paging block;
connecting the first call to an emergency service center;
receiving a second emergency call from the emergency service center after terminating the first emergency call; and
paging the wireless portable communication device in the appropriate paging block.

18. The method of claim 17, receiving a first emergency call from the wireless portable communication device by receiving equipment identity information of the wireless portable communication device along with the first emergency call.

19. The method of claim 18, after assigning a channel for the first emergency call:
assigning a temporary telephone number to the wireless portable communication device by mapping the temporary telephone number to the equipment identity information of the wireless portable communication device; and
maintaining the temporary telephone number for the predetermined period of time.

20. The method of claim 19, providing the temporary telephone number to the emergency service center after connecting the first call to the emergency service center.

21. The method claim 20, receiving a second emergency call from the emergency service center after terminating the first emergency call by receiving the second emergency call having the temporary telephone number from the emergency service center.

22. The method of claim 21, identifying the wireless portable communication device based upon the mapping of the temporary telephone number to the equipment identity information of the wireless portable communication device.

23. The method of claim 22, paging the wireless portable communication device in the appropriate paging block by:
determining the appropriate paging block based upon the equipment identity information of the wireless portable communication device; and
paging in the determined appropriate paging block.

24. The method of claim 23, maintaining the temporary telephone number for the predetermined period of time by:
storing a start time stamp indicating a start of the predetermined period of time in memory;
tracking an elapsed period of time from the start time stamp.

25. The method of claim 24, using the channel assignment as the start of the predetermined period of time.

26. The method of claim 24, using the termination of the emergency call as the start of the predetermined period of time.

27. The method of claim 24, resetting the start time stamp each time an emergency call is received from the wireless portable communication device.

28. The method of claim 24, resetting the start time stamp each time an emergency call to the wireless portable communication device is received from the emergency service center.
